(19) United States
(12) Patent Application Publication
(10) Pub. No.: US 2015/0331790 A1
(43) Pub. Date: Nov. 19, 2015

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Kazuya Kishi, Kawasaki-shi (JP); Kenichi Okihara, Yokosuka-shi (JP); Nobuhiro Tagashira, Sagamihara-shi (JP); Keisuke Matsui, Tokyo (JP)

(21) Appl. No.: 14/710,161

(22) Filed: May 12, 2015

(30) Foreign Application Priority Data
May 14, 2014 (JP) 2014-100844

(51) Int. Cl. G06F 12/02

(52) U.S. Cl. CPC G06F 12/0246; G06F 12/0253; G06F 2212/7201; G06F 2212/7205

(57) ABSTRACT

In a non-volatile memory such as a NAND flash memory, notification of an area that is no longer needed is provided by a TRIM command, and deletion of the unneeded area is executed by garbage collection. The TRIM command and execution of the garbage collection are detected, and notification thereof is provided, whereby the user can confirm that the data on a solid state drive is invalidated.

### BACKGROUND

1. Field

Aspects of the present invention generally relate to an information processing apparatus using a non-volatile memory such as a flash memory, an information processing method, and a storage medium.

2. Description of the Related Art

In recent years, a semiconductor disk (solid state drive, hereinafter referred to as “SSD”) using a flash memory as a storage medium has increasingly been used as an alternative storage to a hard disk drive (HDD) of an information processing apparatus. Compared to the HDD, the SSD is advantageous in that not only high-speed random access is possible but also the SSD is low in power consumption, highly resistant to shock, lightweight, and space-saving.

However, there is an upper limit on the number of times data can be written to a flash memory included in the SSD. Thus, a flash memory controller included in the SSD evenly spreads writing destination areas to prevent concentration of writing to a specific area of the flash memory so that a storage element defect will not occur at an early stage. More specifically, the flash memory controller changes a correspondence between logical and physical addresses of the flash memory to equalize the number of times of writing to the flash memory. For example, when new writing is to be executed, a physical address of a free space with the smallest number of times of writing is arranged to correspond to a logical address specified by the writing request. In this way, the service life of the flash memory, i.e., SSD, is prolonged. This technology is called wear leveling.

Meanwhile, from the security point of view, it may be desired to prohibit data used in processing such as printout processing from being reused after the processing. For example, Japanese Patent Application Laid-Open No. 2012-018501 discusses a method that encrypts data to be invalidated, writes the encrypted data to an SSD, and then deletes an encryption key to make it difficult to reuse the data.

Further, there is another known method in which an area of an HDD that holds data used in processing such as printout processing is overwritten by dummy data (fixed value, random value, etc.). However, in a conventional SSD, it is difficult to overwrite data that is to be invalidated, because writing destination areas are spread by wear leveling and the correspondences between the physical and logical addresses are changed.

The technique discussed in Japanese Patent Application Laid-Open No. 2012-018501 relies on the capability of an encryption protocol and does not achieve deleting the data itself on the SSD. A non-volatile memory such as the SSD receives a notification of an area that is no longer needed, as a command (referred to as “a notification command” or “a deletion command”) from an external apparatus, and executes deletion processing based on the received information. However, the timing of executing the deletion processing based on the notification command varies depending on the specifications of the SSD. This makes it difficult for the user to recognize whether the deletion processing on the data relating to processing executed in an application has been completed in the SSD based on the notification command.

### SUMMARY

According to an aspect of the present invention, an information processing apparatus includes a reception unit configured to receive a job, a storage unit including a non-volatile memory configured to hold data relating to the job, a processing unit configured to execute processing specified using the data held in the non-volatile memory, an output unit configured to issue to the storage unit a deletion request for deleting from the non-volatile memory the data relating to the job processed by the processing unit, an acquisition unit configured to make an inquiry to the storage unit about a data deletion status of the non-volatile memory and acquire status information indicating the data deletion status from the storage unit, and a notification unit configured to provide, based on the status information, notification indicating that the data relating to the job is deleted from the non-volatile memory.

Further features of the present disclosure will become apparent from the following description of exemplary embodiments with reference to the attached drawings.

### BRIEF DESCRIPTION OF THE DRAWINGS

FIGS. 1A and 1B are schematic diagrams illustrating an entire configuration and a functional configuration of an information processing apparatus, respectively.

FIG. 2 is a schematic diagram illustrating a configuration example of a solid state drive (SSD).

FIGS. 3A and 3B schematically illustrate a data configuration of the SSD.

FIGS. 4A and 4B are schematic diagrams illustrating a basic configuration of the information processing apparatus.

FIGS. 5A and 5B are schematic diagrams illustrating a basic configuration of the information processing apparatus.

FIGS. 6A and 6B each illustrate an example of a management table.

FIGS. 7A and 7B each are a flowchart illustrating processing executed by an application.

FIGS. 8A, 8B, and 8C each are a flowchart illustrating processing executed by a file system.

FIGS. 9A, 9B, and 9C each are a flowchart illustrating processing executed by the SSD.

### DESCRIPTION OF THE EMBODIMENTS

Various exemplary embodiments will be described below with reference to the attached drawings.

<Entire Configuration of Information Processing Apparatus>

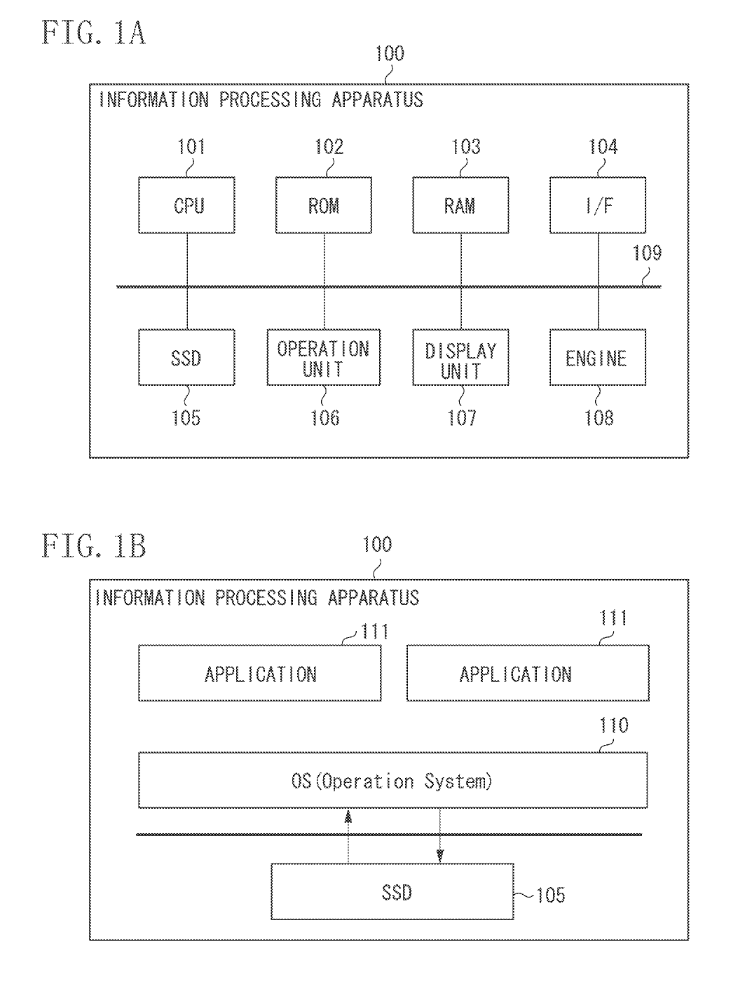

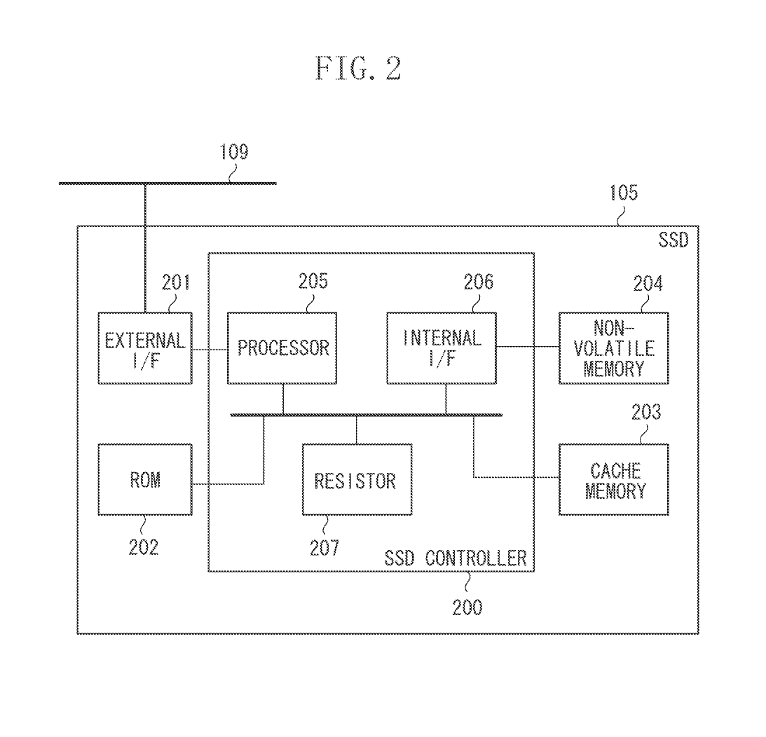

FIG. 1A illustrates an example of an entire configuration of an information processing apparatus 100 according to a first exemplary embodiment.

In FIG. 1A, the information processing apparatus 100 includes a central processing unit (CPU) 101, a read-only memory (ROM) 102, a random access memory (RAM) 103, an interface (I/F) 104, a solid state drive (SSD) 105, an operation unit 106, a display unit 107, and an engine 108, all of which are connected to one another via a bus 109.

The CPU 101 controls the operation of each unit of the information processing apparatus 100 according to the contents of the ROM 102, and executes a program (operation system (OS) or application) loaded into the RAM 103. The ROM 102 is a read-only memory and stores a boot program, firmware, various types of processing programs for realizing processing described below, and various types of data. The RAM 103 is a work memory for temporarily storing a program and/or data to be processed by the CPU 101. The CPU 101 loads various types of processing programs (application and operation system described below) and data into the RAM 103.

The I/F 104 is an interface for communicating with an external apparatus such as a network device and a universal serial bus (USB) device. The I/F 104 performs data communication via a network, and transmits and receives data to and from the external apparatus. The SSD 105 stores an operating system, various types of programs, or various types of data. The SSD 105 is a non-volatile storage device (non-volatile memory) using a NAND flash memory.

The operation unit 106 is a user interface for receiving various types of user instructions such as operation instructions and various parameter settings. The operation unit 106 includes at least one of a keyboard, a mouse, a numeric keypad, and a touch panel. The display unit 107 is a display apparatus for notifying the user of operation confirmation, processing status, etc. The display unit 107 includes at least one of a display and a touch panel. The engine 108 is an optional processing unit and executes various types of processing such as printing and reading in response to an instruction from the user. The engine 108 is, for example, a printer engine for printing image data on a sheet or a scanner engine for scanning image data from a recording medium. For example, the printer engine is a processing unit configured to control a plurality of printer heads according to bitmap data, and the scanner engine is a processing unit configured to transfer image data acquired by a licensor to the RAM 103.

The information processing apparatus 100 may be a widely used personal computer or a multifunction peripheral. The information processing apparatus 100 may be any apparatus that can perform at least one of various types of operation such as printing, scanning, and copying with the engine 108 in response to an instruction given with the operation unit 106.

FIG. 1B illustrates a program configuration of the information processing apparatus 100 according to the present exemplary embodiment. The information processing apparatus 100 according to the present exemplary embodiment runs an OS 110 and a plurality of applications 111. The plurality of applications 111 are run on the OS 110.

The applications 111 may be any applications that perform information processing. For example, the applications 111 may include a document editing application, an image editing application, a web connection application, a print processing application, a scan processing application, a copy processing application. In the case of writing data to the SSD 105, the application 111 executes writing processing via the OS 110. Reading processing is also performed in a similar way. At this time, the OS 110 specifies a logical address of the SSD 105 to read/write data from/to the SSD 105.

The SSD 105 converts the logical address included in the writing or reading request from the OS 110 into a physical address by use of an address conversion table, and accesses the non-volatile memory of the SSD 105.

In the present exemplary embodiment, the application 111 and the OS 110 issue to the SSD 105 a deletion instruction for deleting data relating to a job, and acquire status information (file deletion information and page deletion information described below) indicating a data deletion status relating to the deletion instruction.

### <Configuration of SSD>

FIG. 2 illustrates a configuration of the SSD 105. The SSD 105 includes a SSD controller 200, an external I/F 201, a ROM 202, a cache memory 203, and a non-volatile memory 204 (hereinafter, referred to simply as “non-volatile memory”). Further, the SSD controller 200 includes a processor 205, an internal I/F 206, and a resistor 207.

The SSD controller 200 controls the entire part of the SSD 105. The SSD controller 200 writes data to the non-volatile memory 204 based on a write command and data received from the CPU 101 of the information processing apparatus 100 or a direct memory access controller (DMAC) (not illustrated) via the bus 109 and the external I/F 201. The SSD controller 200 reads data from the non-volatile memory 204 based on a read command. The SSD controller 200 may temporarily store the written data or the read data in the cache memory 203 during the foregoing processing. The ROM 202 is a read-only memory and stores various types of programs and data to be used in the SSD 105. The cache memory 203 temporarily holds data in the non-volatile memory 204 during the execution of the processing by the SSD controller 200. In the present exemplary embodiment, the non-volatile memory 204 is a NAND flash memory.

### <Processing of SSD>

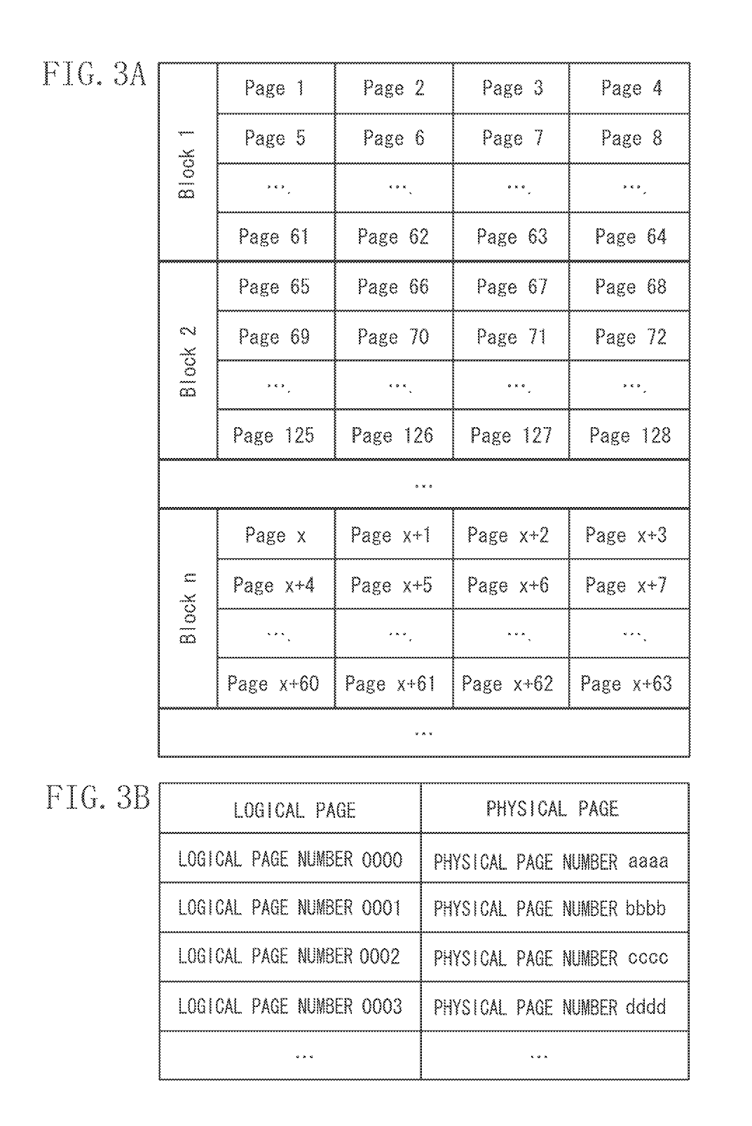

FIGS. 3A and 3B illustrate a configuration of a storage area of the SSD 105. The SSD 105 manages data in units of pages (first unit) and in units of blocks (second unit) (hereinafter, data in units of pages will be referred to as “page data”). A page is the minimum unit of writing/reading processing and generally has several kilo bytes. A block is the unit of deletion processing and includes a plurality of pages. FIG. 3A illustrates an example in which one block includes 64 pages. The SSD 105 cannot directly overwrite a page to which data has already been written. Before writing data to the page, the SSD 105 needs to execute deletion processing. The deletion processing needs to be executed not in units of pages but in units of blocks as the unit of deletion. Thus, in the case of executing data writing processing when there is no page from which data has been deleted and to which data can be written, the SSD 105 executes block deletion processing prior to the writing processing.

To delete blocks, a TRIM command and garbage collection are used. The TRIM command is a command according to the Advanced Technology Attachment (ATA) standard by which the OS 110 informs the SSD 105 of an area (page) that is no longer needed. The garbage collection is a mechanism for reallocating valid pages to generate erasable blocks that include only invalid pages and then performing block deletion processing to increase free blocks. By the TRIM command and the garbage collection, the block deletion processing is performed prior to the writing processing to realize elimination of the block deletion processing during the writing processing. In the present exemplary embodiment, the garbage collection is performed following issuance of a notification of invalid pages by the TRIM command, whereby more efficient block deletion processing is realized.

Further, as illustrated in FIG. 3B, the SSD 105 holds in the internal I/F 206 a correspondence table (address conversion table) indicating correspondences between logical and physical addresses. The SSD 105 executes data writing/reading processing based on the correspondence table. For example, the SSD controller 200 moves data that is frequently changed to a physical page with a small number of times of writing, while moving data that is not frequently changed to a physical page with a large number of times of writing, whereby physical data writing areas can be spread. At this time, the correspondence table is updated to associate an address of a physical page to which the data is to be moved, with an original logical address. Further, in a case where a new request for writing processing is received, data can be written preferentially to an area with a small number of times of writing. This mechanism is called wear leveling. Further, the SSD controller 200 can execute error correction coding processing using a configuration (not illustrated) during the data reading/writing processing.

Further, a correspondence relationship between a logical page and a physical page and a correspondence between a physical page and a block can be acquired by referring to page and block management information (block management information) illustrated in FIGS. 3A and 3B. For example, a block corresponding to a logical page can be identified by referring to a logical page, a physical page, and a block in this order in the management information. On the other hand, a logical page corresponding to a block can be identified by referring to a block, a physical page, and a logical page in this order in the management information.

### <Basic Configuration of Information Processing Apparatus>

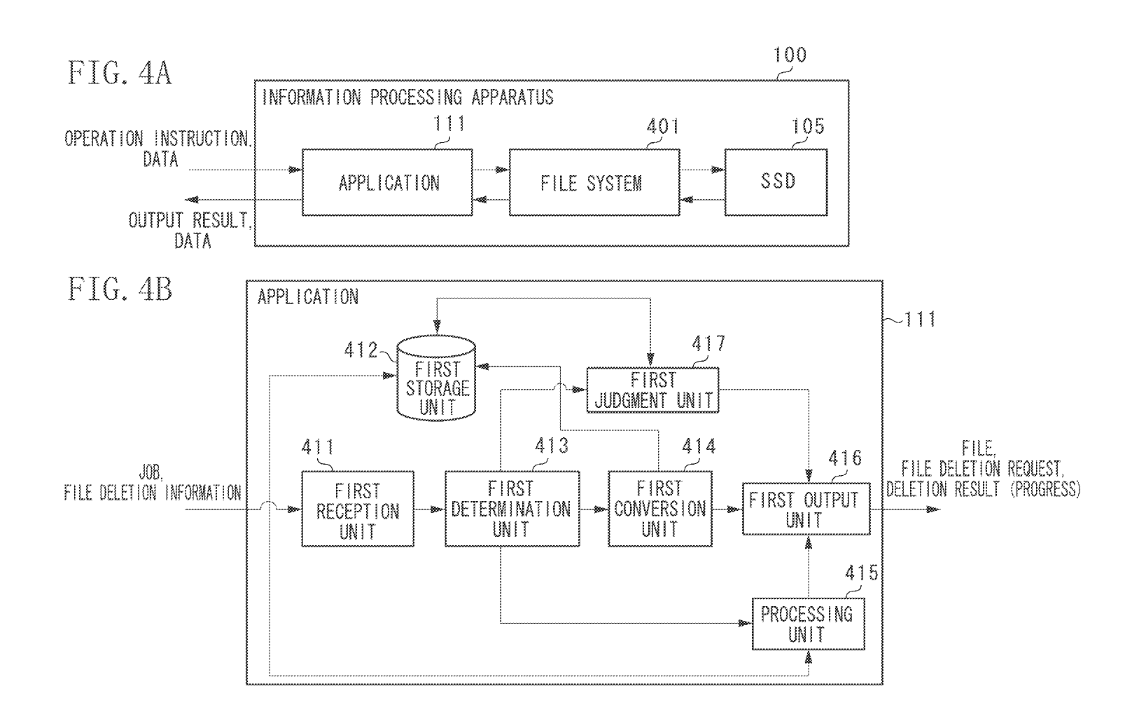

FIG. 4A illustrates a basic configuration of file input/output of the information processing apparatus 100 according to the present exemplary embodiment. As illustrated in FIG. 4A, the information processing apparatus 100 includes the application 111, a file system 401, and the SSD 105. The application 111, the file system 401, and the SSD 105 will be described in detail below.

The application 111 of the information processing apparatus 100 receives a user's operation instruction and data, and the received operation instruction and data are processed by the file system 401 or the SSD 105. In a case where the information processing apparatus 100 is an MFP, the data is, for example, various types of data such as an image file and a document file included in various types of jobs such as a print job and a copy job. Further, the operation instruction is, for example, processing settings included in a print job or a copy job, or a file operation instruction for, for example, deleting a file or copying a file. When an operation instruction and data is input, the application 111 requests the file system 401 to execute file input/output processing such as writing/reading or deleting a file.

When receiving a response to the request for executing the file input/output processing from the file system 401, the application 111 displays the result to the user. The file system 401 processes a file in response to the input/output processing request from the application 111 and transmits a result of the processing to the application 111. At the same time, the file system 401 requests the SSD 105 to execute input/output processing such as physical reading/writing and deletion of data. When receiving the data input/output processing request from the file system 401, the SSD 105 executes the requested processing and transmits a result of the processing to the file system 401. The following describes in detail the applications 111, the file system 401, and the SSD 105 included in the information processing apparatus 100. More specifically, processing relating to completion of a job from the input of the job to the complete deletion of data in the SSD 105 will be described.

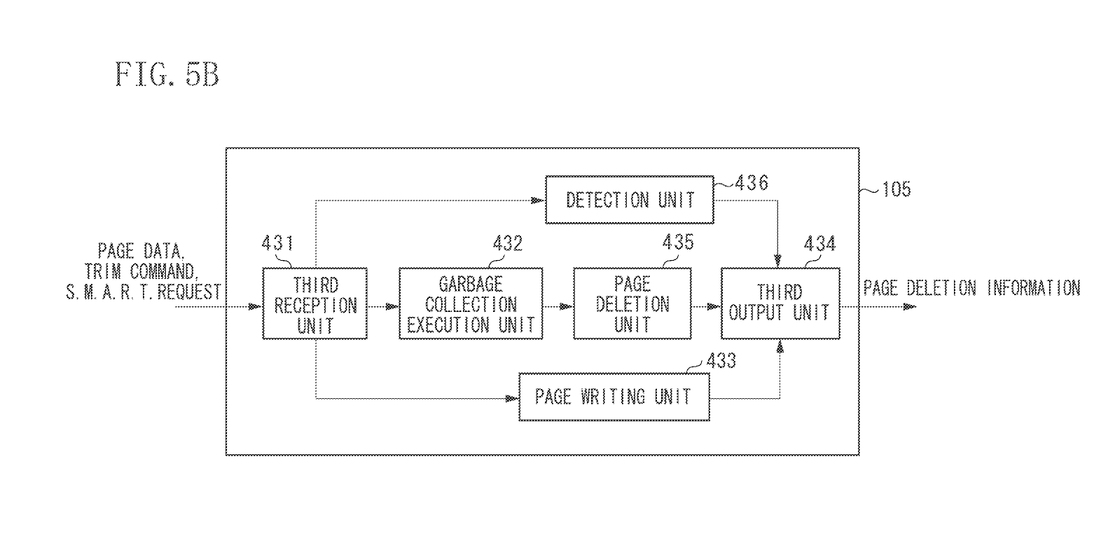

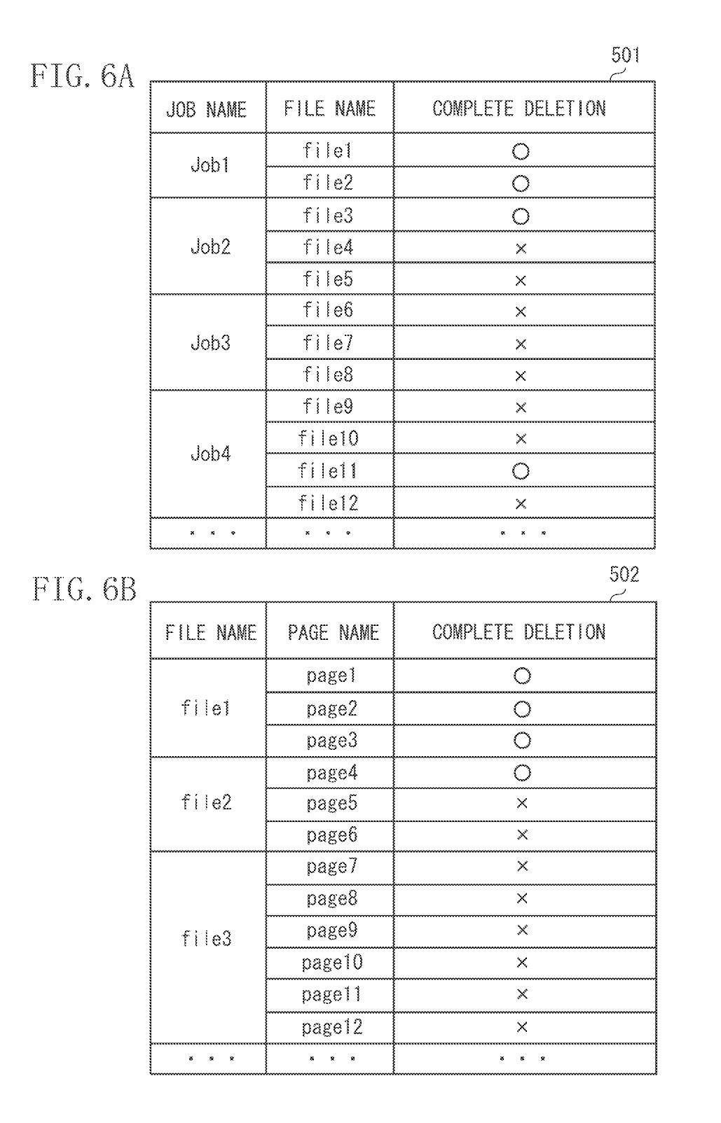

The following describes a job information management table 501 to be accessed by the applications 111 and the file system 401, with reference to FIG. 6A. The job information management table 501 is a table that associates and stores the following three items, “job name,” “file name”, and “complete deletion” with one another.

The “job name” indicates the name of a job input by the user. The “job name” is not limited to the name of the job and may be an identifier such as job identification (ID) by which the job can be identified. The “file name” indicates the file name assigned when the job is converted into a file by a first conversion unit 414. Like the job name, the “file name” may be an identifier such as file ID by which the file can be identified.

The “complete deletion” indicates whether a file relating to the job is completely deleted. In a case where the file is completely deleted, any part of actual data of the file deleted on the file system does not remain in the non-volatile memory. While the present exemplary embodiment uses a circle to indicate that the file is completely deleted, and a cross to indicate that the file is not completely deleted, any other form may be used as long as whether the file is completely deleted can be checked. For example, a check mark may be used for a file that is completely deleted. While the present exemplary embodiment mainly describes using the job information management table 501 in the file writing/deletion processing, the job information management table 501 can also be used in the file reading processing. As used herein, a file deleted on the file system refers to a file invalidated by the file system 401.

FIG. 4B illustrates a functional configuration of the application 111 according to the present exemplary embodiment. As illustrated in FIG. 4B, the application 111 includes a first reception unit 411, a first storage unit 412, a first determination unit 413, the first conversion unit 414, a processing unit 415, a first output unit 416, and a first judgment unit 417. The first reception unit 411 receives a job input by the user. Further, the first reception unit 411 receives information of a file deleted on the file system 401 from the file system 401 as file deletion information. The file deletion information will be described below. The first reception unit 411 outputs the received job and file deletion information to the first determination unit 413. The first storage unit 412 is a logical memory area allocated to the application 111 and physically includes areas such as the RAM 103 and the SSD 105.

Further, the first reception unit 411 can transmit a file reading request (not illustrated) to the file system 401. The first determination unit 413 determines whether the information received by the first reception unit 411 is a job or file deletion information. In the present exemplary embodiment, the job includes data to be processed mainly by the engine 108 (or link information or identification information for reading the data to be processed from an external apparatus) and information indicating details of processing that is to be performed by the engine 108. If the first determination unit 413 determines that the first reception unit 411 receives a job, the first determination unit 413 outputs the job to the first conversion unit 414 and the processing unit 415. On the other hand, if the first determination unit 413 determines that the first reception unit 411 receives file deletion information, the processing is moved to the first judgment unit 417. When receiving the job from the first determination unit 413, the processing unit 415 performs processing based on the job, and when the processing is completed, the processing unit 415 outputs a notification of the completion of the job to the first output unit 416.

Then, when the job processing is completed, the processing unit 415 refers to the job information management table 501 stored in the first storage unit 412, and outputs to the first output unit 416 a file deletion request for deleting a file corresponding to the completed job. In a case where the information processing apparatus 100 is an MFP, the job processing is, for example, various types of processing (rendering processing, color conversion processing, edge processing, etc.) relating to printing, scanning, copying, etc. The first conversion unit 414 converts the job received from the first determination unit 413 into a file and outputs the file to the first output unit 416. Further, the first conversion unit 414 updates the job information management table 501 stored in the first storage unit 412, based on the received job and the file. When the job is input from the first determination unit 413, the first conversion unit 414 creates a new entry and writes the job name of the job and the file name of the file generated by converting the job in the job name field and the file name field of the job information management table 501, respectively. The first judgment unit 417 determines whether the job is completely deleted, based on the file deletion information received from the first determination unit 413, and then outputs the determination result to the first output unit 416.

The following describes a method of determining whether a job is completely deleted, based on the job information management table illustrated in FIG. 6A. The file deletion information to be received from the first determination unit 413 is information that indicates which file is completely deleted. The file deletion information to be received may be a list of file names of files that are completely deleted or information that associates each file with information indicating whether the file is completely deleted.

The present exemplary embodiment will describe a case where the first determination unit 413 outputs to the first judgment unit 417 a list of file names of files that are completely deleted. When acquiring the list of file names of files that are completely deleted, the first judgment unit 417 writes information about whether a related file is completely deleted, in the “complete deletion” field of the job information management table 501 managed in the storage unit 412, based on the file deletion information. In the example illustrated in FIG. 6A, the first judgment unit 417 receives as file deletion information a list of file names file1, file2, file3, and file11 that are completely deleted, and updates the job information management table 501 based on the file deletion information.

Next, the first judgment unit 417 refers to the job information management table 501 to check whether the job is completely deleted. The job information management table 501 stores a job and a file related to the job in association with each other. The first judgment unit 417 refers to the “complete deletion” field for the file associated with the job, and if all files associated with the job are completely deleted, the first judgment unit 417 determines that the job is completely deleted. In the example illustrated in FIG. 6A, since file1 and file2 corresponding to job1 are both completely deleted, the first judgment unit 417 determines that job1 is completely deleted. On the other hand, as for job2, the first judgment unit 417 determines that job2 is not completely deleted, because only file3 is completely deleted and file4 and file5 are not completely deleted. In this case, since file3 is deleted among file3, file4, and file5 of job2, the percentage of the deletion can be calculated as about 33%.

In this way, the first judgment unit 417 acquires information about whether each job is completely deleted or the percentage of complete deletion of each job, and outputs the acquired information to the first output unit 416. Then, the first judgment unit 417 deletes from the job information management table 501 the entry relating to the job that is completely deleted.

The first output unit 416 receives the file from the first conversion unit 414, the determination result from the first judgment unit 417, the job completion notification and the file deletion request from the processing unit 415, and outputs each of them to the file system 401 and the user. In the case of receiving the file, the first output unit 416 outputs the received file to the file system 401. Similarly, in the case of receiving the file deletion request from the processing unit 415, the first output unit 416 outputs the file deletion request to the file system 401.

In the cases of receiving the determination result from the first judgment unit 417 and the job completion notification from the processing unit 415, information about the complete deletion of the job and the completion of the job are displayed to the user via the display unit 107 of the information processing apparatus 100. Information about the complete deletion of the job may be displayed to the user only when the job is completely deleted, or the percentage of complete deletion of the job may be displayed.

### <Functional Configuration of File System>

First, a file information management table 502 managed by the file system 401 will be described below with reference to FIG. 6B. The file information management table 502 is a table that holds three items, the file name, the page name, and the complete deletion, in association with one another.

The following describes a relationship between a file and a page. The file system 401 manages a file and data in units of pages (page data) corresponding to the file in association with each other. A page is the minimum unit of the data management of the file system 401, and a file corresponds to one or more pages. In the present exemplary embodiment, the SSD 105 performs data writing processing and data reading processing in units of pages managed by the file system 401. Thus, the file system 401 converts a file into a page(s) and manages the file and the page(s) in associated with each other.

The “file name” indicates the name of a file input from the application 111. An identifier such as file ID by which the file can be identified may also be used. The “page name” indicates the name of a page generated by converting a file by a second conversion unit 424. Like the file name, an identifier such as page ID by which the page can be identified may also be used. The “complete deletion” field indicates whether the page is completely deleted. While the present exemplary embodiment uses a circle to indicate that the page is completely deleted, and a cross to indicate that the page is not completely deleted, any other form may be used as long as whether the page is completely deleted can be checked. For example, a check mark may be used for a page that is completely deleted.

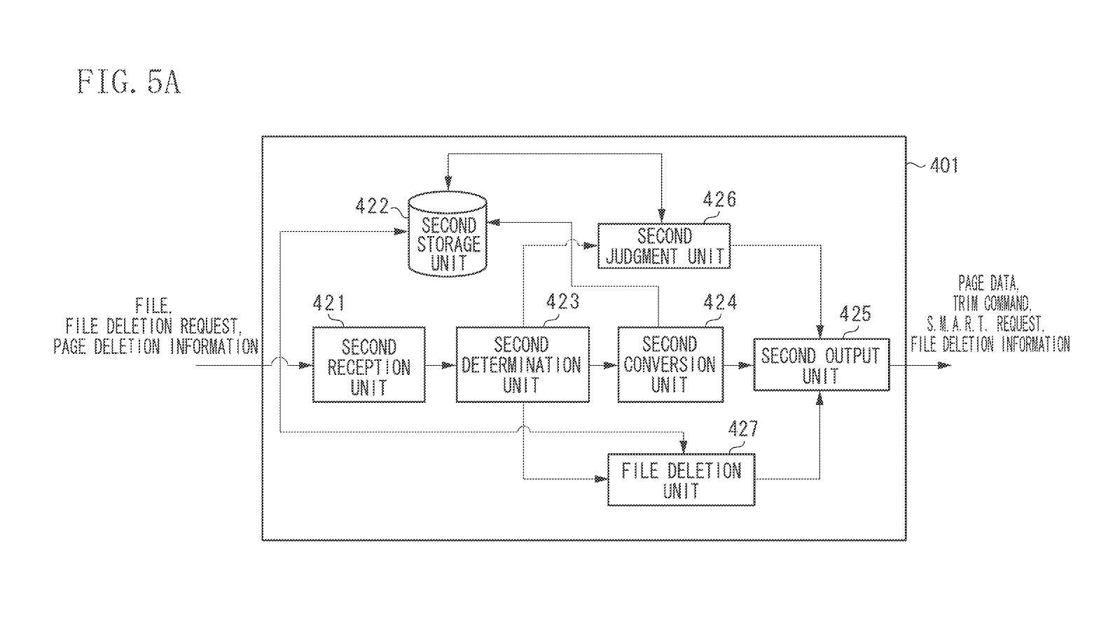

FIG. 5A illustrates a functional configuration of the file system 401 according to the present exemplary embodiment. The file system 401 includes a second reception unit 421, the second storage unit 422, a second determination unit 423, a second conversion unit 424, a second output unit 425, a second judgment unit 426, and a file deletion unit 427. The second reception unit 421 receives a file or a file deletion request from the application 111. Further, the second reception unit 421 receives from the SSD 105 page deletion information about a deleted page.

The second reception unit 421 receives a file, a file deletion request, or page deletion information, and outputs the information to the second determination unit 423. The second determination unit 423 determines whether the information received by the second reception unit 421 is a file, a file deletion request, or page deletion information. If the second determination unit 423 determines that the received information is a file, the second determination unit 423 outputs the file to the second output unit 425. Further, if the second determination unit 423 determines that the received information is a file deletion request, the second determination unit 423 outputs the file deletion request to the file deletion unit 427. Further, if the second determination unit 423 determines that the received information is page deletion information, the processing is moved to the second judgment unit 426. When receiving the file from the second determination unit 423, the second conversion unit 424 converts the received file into one or more pages and outputs the page(s) to the second output unit 425. Further, the second conversion unit 424 updates the file information management table 502 stored in the second storage unit 422, based on the received file or the file deletion information.

After converting the received file into page(s), the second conversion unit 424 creates a new entry and writes the file name of the file and the page name of each page corresponding to the file, in the “file name” field and the “page name” field of the file information management table 502, respectively. The second judgment unit 426 determines whether the file is completely deleted, based on the page deletion information received from the second determination unit 423. Then, the second judgment unit 426 outputs the determination result to the second output unit 425. The determination processing performed by the second judgment unit 426 will be described below.

The second judgment unit 426 outputs to the second output unit 425 the determination result that indicates whether the file is completely deleted. Then, the second judgment unit 426 deletes from the file information management table 502 the entry relating to the file determined as being completely deleted. If the entry is deleted too early, it becomes impossible to recognize whether the deletion is completed. Thus, the entry may be deleted at the time of next restart or shutdown. When receiving the file deletion request from the second determination unit 423, the file deletion unit 427 refers to the file information management table 502 stored in the second storage unit 422. Then, the file deletion unit 427 identifies the page(s) corresponding to the file specified as a complete deletion target in the file deletion request, and outputs to the second output unit 425 a page deletion request for deleting the identified page(s).

The second output unit 425 receives the page data to be written to or read from the SSD 105 from the second conversion unit 424, receives the determination result from the second judgment unit 426, or receives the page deletion request from the file deletion unit 427. Then, the second output unit 425 outputs the received page data, the received determination result, or the received page deletion request to the application 111 or the SSD 105.

More specifically, in the case of receiving from the second conversion unit 424 the page data to be written to the SSD 105, the second output unit 425 outputs the received page data to the SSD 105. Further, in the case of receiving the page data read from the SSD 105, the second output unit 425 outputs the received page data to the application 111. Further, in the case of receiving the page deletion request from the file deletion unit 427, the second output unit 425 outputs the received page deletion request to the SSD 105 as a TRIM command. Further, in the case of receiving the determination result from the second judgment unit 426, the second output unit 425 outputs the received determination result as file deletion information to the application 111. Then, the second output unit 425 issues to the SSD 105 a command for acquiring S.M.A.R.T. (Self-Monitoring, Analysis and Reporting Technology) information. Hereinafter, the command for acquiring S.M.A.R.T. information will be referred to simply as a SMART request.

As used herein, the SMART request refers to an inquiry for acquiring, from an external apparatus located outside the HDD or SSD, a quantified status of the storage unit such as the HDD or SSD that has been obtained by real-time self-monitoring of various types of inspection items of the storage unit and has been stored in the storage unit. While the present exemplary embodiment describes a “status of page deletion (data deletion status)” as an example of the inspection items, the inspection item may be any other inspection item such as the number of errors as long as the item indicates the status of the SSD. Further, in the present exemplary embodiment, the status of the SSD is acquired by the SMART request. However, the acquisition method is not limited to the SMART request, and any method by which the status of the SSD can be acquired may be used. For example, the status of the SSD may be acquired by collecting information within the SSD 105 and periodically outputting the collected information to the file system 401. Alternatively, the SSD 105 may output the status of the SSD by periodic polling from the file system 401. The present exemplary embodiment will describe a case where the SMART request is issued simultaneously with the issuance of the TRIM command. As for the timing of the SMART request, the SMART request may be issued periodically at predetermined intervals or in response to an instruction from the OS 110 or the application 111.

The following describes the method by which the second judgment unit 426 determines whether a file is completely deleted, based on the file information management table 502 illustrated in FIG. 6B. The page deletion information to be received by the second judgment unit 426 from the second determination unit 423 is information that indicates which page is completely deleted. The page deletion information to be received may be a list of page names of pages that are completely deleted or may be information that indicates whether complete deletion of each page is completed. The present exemplary embodiment will describe a case where the second determination unit 423 outputs to the second judgment unit 426 a list of page names of pages that are completely deleted, as page deletion information. When acquiring the page deletion information from the second determination unit 423, the second judgment unit 426 writes information about whether the page is completely deleted, in the “complete deletion” field of the file information management table 502 stored in the storage unit 422, based on the page deletion information.

FIG. 6B illustrates the file information management table 502 updated by the second judgment unit 426 that has received, as page deletion information, the page names page1, page2, page3, and page4, all of which indicate the pages that are completely deleted. After updating the file information management table 502, the second judgment unit 426 checks whether the file is completely deleted, based on the file information management table 502. In the file information management table 502, the file and the page(s) relating thereto are managed in association with each other. The second judgment unit 426 refers to the complete deletion field of each page associated with the file, and if all the pages associated with the file are completely deleted, the second judgment unit 426 determines that the file is completely deleted.

In FIG. 6B, all of the pages associated with file1, that is, all of page1, page2, and page3 are completely deleted. Thus, the second judgment unit 426 determines that file1 is completely deleted. On the other hand, as for file2, only page4 is deleted among the pages associated with file2, that is, page4, page5, and page6. Thus, the second judgment unit 426 determines that file2 is not completely deleted.

### <Functional Configuration of SSD>

FIG. 5B illustrates a functional configuration of the SSD 105. As illustrated in FIG. 5B, the SSD 105 includes a third reception unit 431, a garbage collection execution unit 432, a page writing unit 433, a third output unit 434, a page deletion unit 435, and a detection unit 436. The functional configuration can be realized by the SSD controller 200 executing a program stored in the ROM 202 or by hard logic included in the SSD controller 200.

In a case where the information received from the file system 401 is page data, the third reception unit 431 outputs the page data to the page writing unit 433. Further, in a case where the information received from the file system 401 is a TRIM command, the third reception unit 431 outputs the received TRIM command to the garbage collection execution unit 432. Further, in a case where the information received from the file system 401 is a SMART request, the third reception unit 431 outputs the SMART request to the detection unit 436.

The garbage collection execution unit 432 (hereinafter, simply referred to as “execution unit 432”) executes garbage collection based on the TRIM command input from the third reception unit 431. When the execution unit 432 completes the execution of garbage collection, the page deletion unit 435 deletes a block that is not in use. The block that is not in use refers to a block in which either no page data or invalid page data is written to every page corresponding to the block. The page deletion unit 435 can completely delete the data stored in the block, by using the block units.

When the deletion of the block is completed, the page deletion unit 435 outputs a notification of the completion of deletion to the third output unit 434. When the page data is input from the third reception unit 431, the page writing unit 433 writes the input page data to the non-volatile memory 204. When the writing is completed, the page writing unit 433 outputs a notification of the completion of writing to the third output unit 434.

When the SMART request is input from the third reception unit 431, the detection unit 436 detects information in the SSD 105 based on the SMART request. In the present exemplary embodiment, the information to be detected is a page deletion status. Thus, the detection unit 436 detects information about the deleted page from the non-volatile memory 204 or the resistor 207, extracts the detected information, and outputs the extracted information to the third output unit 434. As described above, the third output unit 434 receives the notification of completion of writing to the page from the page writing unit 433, receives the notification of completion of deletion from the page deletion unit 435, or receives the detection result from the detection unit 436. In the present exemplary embodiment, the third output unit 434 outputs to the file system 401 the detection result input from the detection unit 436, as page deletion information.

<Processing Flow in Application>

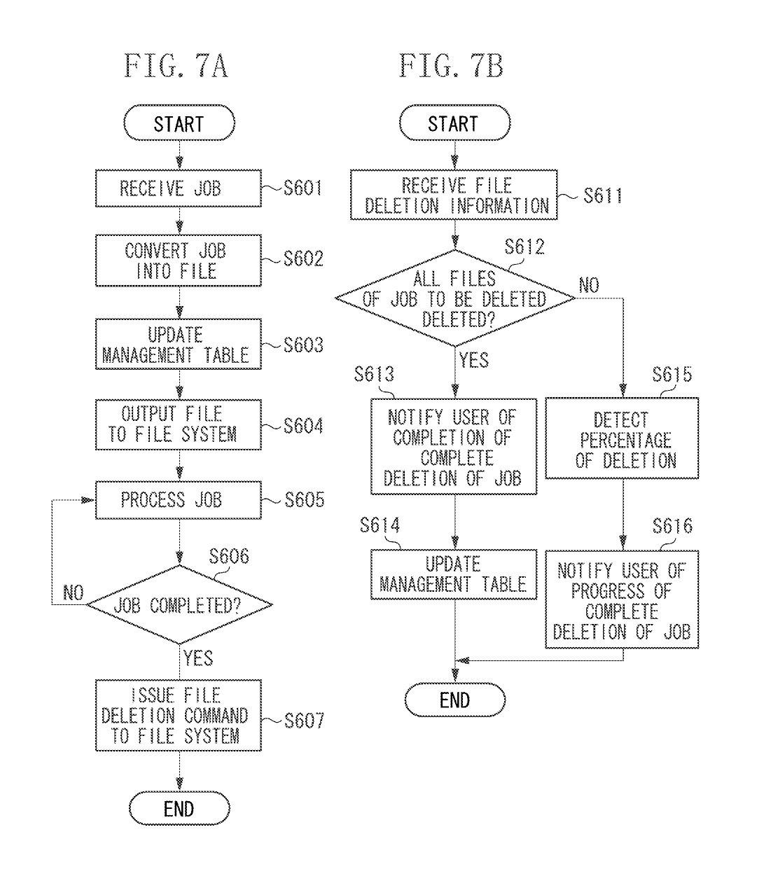

The following describes the processing flow in the application 111 with reference to FIGS. 7A and 7B. In the following description, the processing flow in the application 11 is divided into a job processing flow A and a job deletion confirmation flow B. The CPU 101 realizes each processing of the application 111 by reading and executing a program stored in the ROM 102 or the RAM 103.

First, the job processing flow in the application 111 will be described below with reference to FIG. 7A. First, in step S601, the first reception unit 411 of the application 111 receives a job from the user. Then, in step S602, the first conversion unit 414 converts the received job into a file. When completing the conversion, in step S603, the first conversion unit 414 updates the job information management table 501 by adding information associating the job with the file thereto. Thereafter, in step S604, the first output unit 416 outputs the file to the file system 401. In step S605, the processing unit 415 processes the job.

In step S606, the processing unit 415 determines whether the job is completed. If the job is not completed (NO in step S606), the processing returns to step S605, and the processing is continued until the job is completed. When the job is completed (YES in step S606), the processing unit 415 notifies the first output unit 416 of the completion of the job, and in step S607, the first output unit 416 issues a file deletion command to the file system 401. Then, the job processing is ended.

Next, the job deletion confirmation flow in the application 111 will be described below with reference to FIG. 7B. In step S611, the first reception unit 411 of the application 111 receives file deletion information from the file system 401. The file deletion information is transmitted to the first judgment unit 417, and in step S612, the first judgment unit 417 determines whether all files of the job to be deleted are deleted, based on the file deletion information and the job information management table 501.

If the first judgment unit 417 determines that all files of the job to be deleted are deleted (YES in step S612), then in step S613, the first judgment unit 417 notifies the user of the completion of complete deletion of the job (or progress of complete deletion) via the first output unit 416. Then, in step S614, the first judgment unit 417 deletes from the job information management table 501 the entry in which the completely deleted job is associated with the file relating to the job. On the other hand, if the first judgment unit 417 determines that complete deletion of all files corresponding to the job to be deleted is not completed (NO in step S612), then in step S615, the first judgment unit 417 calculates the percentage of the complete deletion of the file corresponding to the job to be deleted. Then, in step S616, the first judgment unit 417 notifies the user of information indicating the progress of the complete deletion of the job via the first output unit 416, and the job deletion confirmation processing is ended. The job deletion confirmation processing may be performed in a parallel manner or in response to a confirmation request from the user, after the file system 401 and the SSD 105 start the processing relating to the complete deletion based on the file deletion command.

### <Processing Flow in File System>

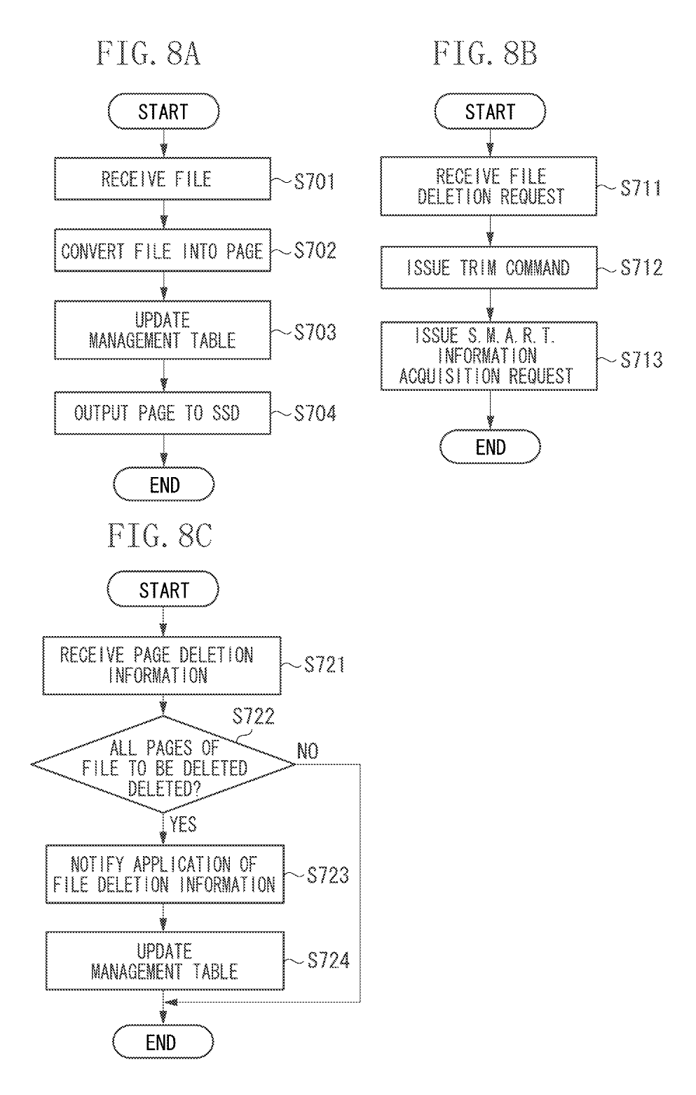

The following describes the processing flow in the file system 401 with reference to FIGS. 8A, 8B, and 8C. In the following description, the processing flow in the file system 401 is divided into three flows, a file writing flow, a file deletion request flow, and a file deletion confirmation flow. The CPU 101 realizes each processing in the file system 401 by reading and executing a program stored in the RAM 103.

First, the file writing flow will be described with reference to FIG. 8A. First, in step S701, the second reception unit 421 of the file system 401 receives a file from the application 111. In step S702, the second conversion unit 424 converts the received file into a page(s). When completing the conversion, in step S703, the second conversion unit 424 associates the target file with the page(s) and updates the file information management table 502. Then, in step S704, the second conversion unit 424 outputs the page(s) to the SSD 105 via the second output unit 425, and the file writing processing is ended. The file writing processing is performed, for example, in a case where a file received from the user separately from a job is input from the application 111 or a case where the application 111 having received a job acquires and inputs a file to be processed in the job.

Next, the file deletion request flow will be described with reference to FIG. 8B. First, in step S711, the second reception unit 421 of the file system 401 receives a file deletion request from the application 111. Then, in step S712, the file deletion unit 427 issues a TRIM command to the SSD 105 by use of the second output unit 425. Then, in step S713, the second output unit 425 issues a SMART request to the SSD 105, and the file deletion request processing is ended.

Next, the file deletion confirmation flow will be described with reference to FIG. 8C. First, in step S721, the second reception unit 421 of the file system 401 receives page deletion information from the SSD 105. After the page deletion information is received, in step S722, the second judgment unit 426 determines whether each page relating to the file to be deleted is deleted, based on the page deletion information and the file information management table 502. If the second judgment unit 426 determines that all pages of the file to be deleted are deleted (YES in step S722), then in step S723, the second judgment unit 426 creates file deletion information and notifies the application 111 of the file deletion information via the second output unit 425. Then, in step S724, the second output unit 425 deletes the page(s) relating to the deleted file from the file information management table 502, and the file deletion confirmation processing is ended.

### <Processing Flow in SSD>

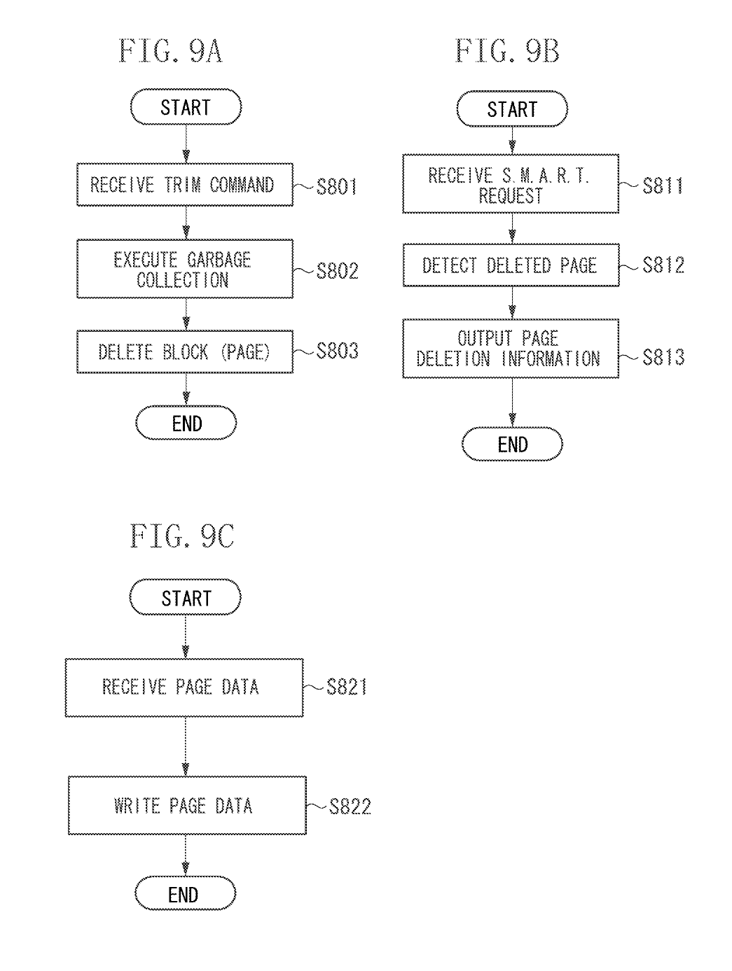

The following describes the processing flow in the SSD 105 with reference to FIGS. 9A, 9B, and 9C. In the following description, the processing flow in the SSD 105 is divided into three flows, a page deletion flow, a SMART request flow, and a page writing flow. Each processing in the SSD 105 is realized by the processor 205 reading and executing a program stored in the ROM 202 or by hard logic in the SSD controller 200.

First, the page deletion flow will be described below with reference to FIG. 9A. In step S801, the third reception unit 431 of the SSD 105 receives a TRIM command from the file system 401. Then, in step S802, the garbage collection (GC) execution unit 432 executes garbage collection. After the garbage collection is executed, in step S803, the page deletion unit 435 deletes an erasable block generated by the garbage collection, and the page deletion processing is ended.

Next, the SMART request flow will be described below with reference to FIG. 9B. In step S811, the third reception unit 431 of the SSD 105 receives a SMART request from the file system 401. Then, in step S812, the detection unit 436 detects a deleted page based on the SMART request. After the detection unit 436 detects the deleted page, in step S813, the third output unit 434 outputs page deletion information indicating the deleted page to the file system 401, and the SMART request processing is ended.

Next, the page writing flow will be described below with reference to FIG. 9C. In step S821, the third reception unit 431 of the SSD 105 receives page data from the file system 401. Then, in step S822, the page writing unit 433 refers to the logical address and physical address correspondence table and writes the page data to the physical area of the non-volatile memory 204, and the page writing processing is ended.

As described above, the present exemplary embodiment allows the user to easily recognize that the data relating to processing executed in an application is completely deleted (or recognize the progress of the complete deletion). Further, since notification of the TRIM command or of execution of the garbage collection is provided, the user can easily recognize that the data on the SSD that relates to the application is deleted.

The TRIM command has been described as an example in the present exemplary embodiment. The TRIM command is the name of a deletion instruction according to the ATA standard. The TRIM command corresponds to an UNMAP command in the Small Computer System Interface (SCSI) standard and may be referred to as a discard command. Using any of the commands can realize the present exemplary embodiment.

While the foregoing exemplary embodiment has described that the SSD 105 executes the data writing processing and the data reading processing in units of pages managed by the file system 401, the unit of management by the file system may be different from the unit of writing to the SSD.

While the foregoing exemplary embodiment has described the processing for completely deleting the data based on which a job is to be processed, the exemplary embodiment is also applicable to completely deleting the data that is generated in relation to job processing. Examples of the data generated in relation to the job processing include rendering data, and bitmap data for each color material.

Furthermore, the foregoing exemplary embodiment has been described using the File Allocation Table (FAT) for the convenience of description. However, the present exemplary embodiment is also applicable to a file system (e.g., New Technology File System (NTFS), ext4, etc.) other than a file system using the FAT table.

Additional embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-100844, filed May 14, 2014, which is hereby incorporated by reference herein in its entirety.

What is claimed is:

1. An information processing apparatus comprising:
a reception unit configured to receive a job;
a storage unit including a non-volatile memory configured to hold data relating to the job;
a processing unit configured to execute processing specified by the job using the data held in the non-volatile memory;
an output unit configured to issue to the storage unit a deletion request for deleting from the non-volatile memory the data relating to the job processed by the processing unit;
an acquisition unit configured to make an inquiry to the storage unit about a data deletion status of the non-volatile memory and acquire status information indicating the data deletion status from the storage unit; and
a notification unit configured to provide, based on the status information, notification indicating that the data relating to the job is deleted from the non-volatile memory.

2. The information processing apparatus according to claim 1, further comprising a judgment unit configured to determine, based on the data deletion status, whether the data relating to the job is deleted from the non-volatile memory.

3. The information processing apparatus according to claim 2, wherein the judgment unit determines whether the data relating to the job is deleted from the non-volatile memory based on a first table that holds information indicating a correspondence between a job received by the reception unit and a file corresponding to the job and a second table that holds information indicating a correspondence between the file and a page in the non-volatile memory.

4. The information processing apparatus according to claim 3, wherein, based on the first table, the judgment unit calculates progress of deletion processing on the data relating to the job.

5. The information processing apparatus according to claim 1, wherein the output unit outputs as the deletion request an instruction for executing garbage collection.

6. The information processing apparatus according to claim 1, wherein the status information indicates whether data held in each page corresponding to a file corresponding to the job is deleted.

7. The information processing apparatus according to claim 1, wherein the non-volatile memory is a solid state drive (SSD).

8. The information processing apparatus according to claim 1, wherein the deletion request is a TRIM command according to an Advanced Technology Attachment (ATA) standard.

9. The information processing apparatus according to claim 1, wherein the inquiry is a command for acquiring Self-Monitoring, Analysis, and Reporting Technology (S.M.A.R.T.) information.

10. An information processing method comprising:
receiving a job;
holding data relating to the job in a non-volatile memory;
executing processing specified by the job using the data held in the non-volatile memory;
issuing a deletion request for deleting from the non-volatile memory the data relating to the job processed in the processing;
inquiring about a data deletion status of the non-volatile memory and acquiring the data deletion status; and
providing, based on the acquired data deletion status, notification indicating that the data relating to the job is deleted from the non-volatile memory.

11. A non-transitory computer-readable storage medium storing a program that causes a computer to execute computer executable instructions for an information processing method, the information processing method comprising:
receiving a job;
holding data relating to the job in a non-volatile memory;
executing processing specified by the job using the data held in the non-volatile memory;
issuing a deletion request for deleting from the non-volatile memory the data relating to the job processed in the processing;
inquiring about a data deletion status of the non-volatile memory and acquiring the data deletion status; and
providing, based on the acquired data deletion status, notification indicating that the data relating to the job is deleted from the non-volatile memory.
